(19) United States
(12) Patent Application Publication
(10) Pub. No.: US 2005/0085240 A1
(43) Pub. Date: Apr. 21, 2005

(54) Wireless locating and communication system

(76) Inventor: Terence M. Fitzgerald, Cobourg (CA)

Correspondence Address: BIRCH STEWART KOLASCH & BIRCH, PO BOX 747, FALLS CHURCH, VA, 22040-0747, US

(21) Appl. No.: 10/965,810

(22) Filed: Oct. 18, 2004

Related U.S. Application Data
(60) Provisional application No. 60/481,523, filed on Oct. 17, 2003.

(51) Int. Cl. H04Q 7/20

(52) U.S. Cl. 455/456.1; 455/456.6

(57) ABSTRACT

A communication system which enables one party to determine the location of another party and which also enables the party so located to carry on wireless communication. The system comprises a targeted transceiver which transmits a target signal identifying the geographical coordinates of the targeted transceiver and a locating transceiver which has means by which the geographical coordinates of the targeted transceiver can be determined. The targeted transceiver and optionally the locating transceiver have means for transmitting and receiving a communication signal which carries verbal and/or text messages.

### FIELD OF THE INVENTION

This invention relates to a wireless communication system which enables one party to determine the location of another party and which also enables the party so located to carry on wireless communication with the party determining his location and with a third party.

### BACKGROUND OF THE INVENTION

Wireless communication systems are known in which one party can determine the geographical position of another by means of positioning technologies such as a global positioning system (GPS), an assisted global positioning system (A-GPS), network based positioning which computes the location of a device by triangulation of wireless signals between transmission towers, a fixed sensor in the environment that identifies a moving object and cell-identification which identifies the cell in which a moving object is located. Such systems are useful for determining the position of a lost child and for tracking the whereabouts of persons under court order, adolescents, hunters, fishermen and so on.

The existing communication systems have many shortcomings. Some lack means by which the person whose geographical position is being sought can communicate with the person who is seeking him or with some third party. Other devices lack means for preventing third parties from disabling them. Should the device be used to determine the geographic location of a child in the hands of an abductor, for example, the device can be damaged by the abductor so that it is inoperative or it can be turned off. Once disabled or turned off, the device no longer serves the intended purpose.

I have invented a communication system which provides the person being sought with the option to communicate by voice or by text messaging with the person who is seeking him and with third parties. The device is provided with a number of features to discourage or prevent it from becoming inoperative without the consent of the person being sought.

### SUMMARY OF THE INVENTION

The communication system of my invention enables one party to determine the location of another party and also enables the party so located to carry on wireless communication. Briefly my system comprises a targeted transceiver which transmits a target signal identifying the geographical coordinates of the targeted transceiver and a locating transceiver which has means by which the geographical coordinates of the targeted transceiver can be determined. The targeted transceiver has means for transmitting and receiving a communication signal which carries verbal and/or text messages.

### DESCRIPTION OF THE DRAWINGS

FIG. 1 is a schematic diagram of the components of the communication system;

FIG. 2 is a perspective view of the transceiver used by the person being sought;

FIG. 3 is another perspective view of the transceiver of FIG. 2;

FIG. 4 is a schematic diagram of the components within the transceiver of FIG. 2;

FIG. 5 is a perspective view of the transceiver used by the person who is doing the locating; and

FIG. 6 is a schematic diagram of the components within the transceiver of FIG. 5.

Like reference characters refer to like parts throughout the description of the drawings.

### DESCRIPTION OF PREFERRED EMBODIMENT

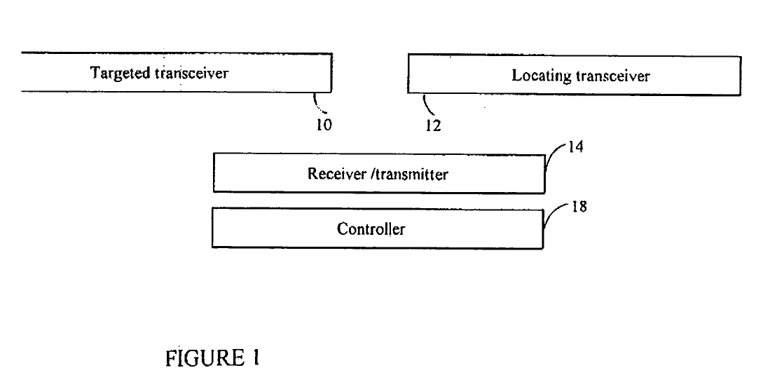

With reference to FIG. 1 the communication system of the invention includes two transceivers, 10, 12. If the transceivers are being used to determine the location of one transceiver by the user of the other, the first transceiver will be used by the person being located or the “target” and the other by the person who is attempting to find the first person or the “locator”. The target can be a child or adolescent and the locator can be a parent or guardian. Alternatively the target may be a hunter or hiker in the bush or a fisherman on a body of water and the locator can be a wife or friend.

For the purpose of simplifying the following description, the first transceiver is referred to as the “targeted device” and the second transceiver the “locating device”. The wireless signals which the transceivers transmit are referred to as the “target” and “locate” signals, respectively. The use of such terms is not intended to restrict the use of such transceivers and the signals which they transmit to the locating of one person by another since the targeted device and optionally the locating device tare also equipped with the means for carrying on wireless communication.

The targeted device is equipped with a geographical locator such as a GPS, A-GPS, and the other positioning technologies mentioned above. Of the various technologies, GPS and A-GPS are the preferred since such systems are in common everyday use and their effectiveness is proven.

The geographic locator determines the coordinates of the targeted device and the coordinates are encrypted by the targeted device into a data package. The targeted device sends the encrypted data in the form of a wireless signal, (the “target signal”) to a receiver-transmitter 14.

The receiver-transmitter may be any kind of cellular transmission system, such as that used for analog cellular telephone services or digital cellular telephone services known as personal communications services or a two-way paging also known as an interactive paging.

The targeted device transmits the target signal continuously or periodically depending upon who has possession of it. If the device is in a child's possession and is being used to determine the location of the child, the targeted device will normally transmit the target signal continuously since a child may not have the capability of turning the device on and off.

Optionally, the targeted device will transmit the target signal only after receipt of a signal originating from a controller 18. The controller will transmit such a “response required” signal upon notification by a parent or guardian that such a signal should be transmitted. Such notification will be communicated to the controller by activation of the locate signal on the locating device by the parent or guardian or by text messaging where the locating device is equipped with a transmission and receipt system.

The locate signal may activate a Voice Response Unit (VRU) that interfaces directly with the controller or it may activate a light or other form of indication to the person who controls the operation of the controller that a “response required” signal should be sent to the targeted device.

The controller may be a computer which is incorporated into the receiver-transmitter or it may stand alone. The controller has many functions including translation of the geographic coordinates communicated to it by the targeted device into a commonly recognized location reference such as a road map. Other functions may be the storage of the location references in memory, communication with a VRU and so on.

If the targeted device is in the possession of an adolescent, it will normally transmit the signal only when the adolescent turns it on since the adolescent will not want all his movements to be monitored by a parent or guardian. Similarly, a hunter or fisherman will not normally consider it necessary to have all his movements monitored and will want the targeted device to transmit only when he wants it to. By means of a simple on-off switch on the targeted device, the adolescent, hunter and fisherman will be able to control when the transmission of the target signal occurs.

The receiver-transmitter that receives the target signal from the targeted device forwards the encrypted data to the locating device where it is decoded. The geographic coordinates are then displayed on the locating device. Alternatively, where the locating device is equipped with a transmission and receipt system, the person who has possession of the locating device can communicate, either person to person or by text messaging with the controller and obtain the geographic coordinates.

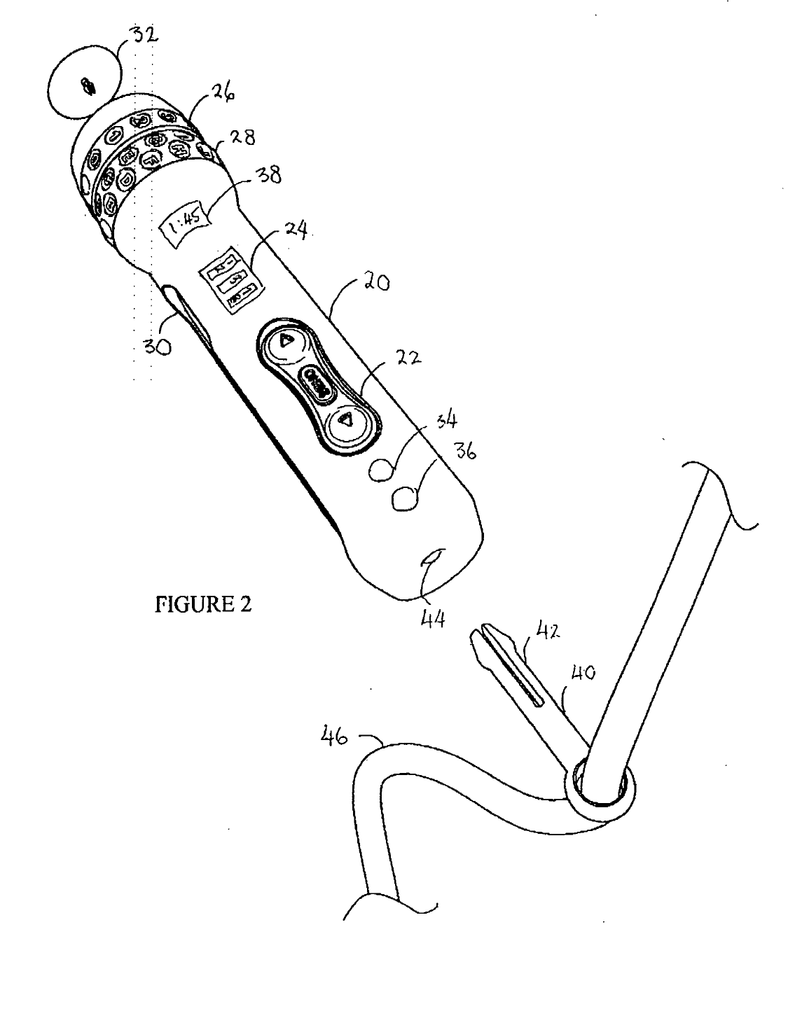

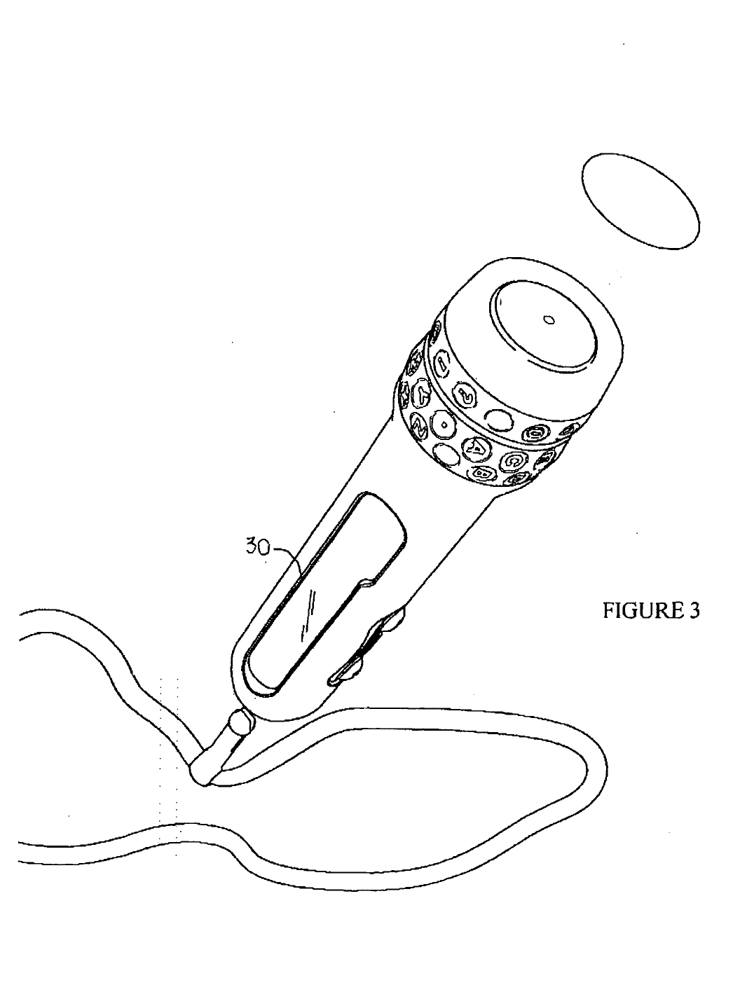

With reference to FIGS. 2 and 3, the target device 20 has an on-off switch 22 which can only be deactivated, once activated, when the numbers on the rotating rings of combination lock 24 are arranged in the sequence required to open the lock. The target device cannot as a result be turned off once it is on unless the lock is opened.

The lock serves two functions: first a young child cannot inadvertently turn the device off once it is activated since he or she lacks the manual dexterity to open the lock; and secondly a potential abductor of the child cannot open the lock since he will not know the combination required to do so and the parent and guardian will obviously not tell the child what the combination is. The combination lock accordingly prevents unauthorized blocking of the target signal from the targeted device.

The target device has a pair of rotating dials 26, 28 at the end of the device. Printed or embossed on dial 26 are numbers and on the other dial letters. The device can be programmed to require that a certain sequence of numbers or letters be entered before the device can be activated and deactivated. A different sequence can be assigned to each user of the device and the device can have memory means for recording each sequence entered so that the device has the means not only of validating the use of the device by individual users but also of recording who those users are.

The targeted device has a LED screen 30 for displaying the geographical coordinates of the device as well as text messages. The device can as a result be used as a compass by its user. The device can also be used to receive text messages typical of a cellular communication device. By mean of dials 26, 28, alphanumeric messages can be displayed on the screen before they are sent to the recipient.

A spring-loaded push button 32 at one end of the target device is provided for entering commands. If desired, button 32 can be programmed to send the target signal should the device be used by an adolescent or adult who wishes to control when the signal is to be transmitted.

The targeted device also has a toggle 34 and a send button 36 for toggling alphanumeric characters on the screen and for sending text messages respectively. A digital clock 38 is also provided on the targeted device.

A clip 40 has a bifurcated end 42 made up of a pair of spaced apart forks which fit into a slot 44 for removable attachment of the targeted device to a belt 46, necklace or other article of clothing of the user of the device. The clip is composed of resilient material and may be removed from the device by squeezing the forks together.

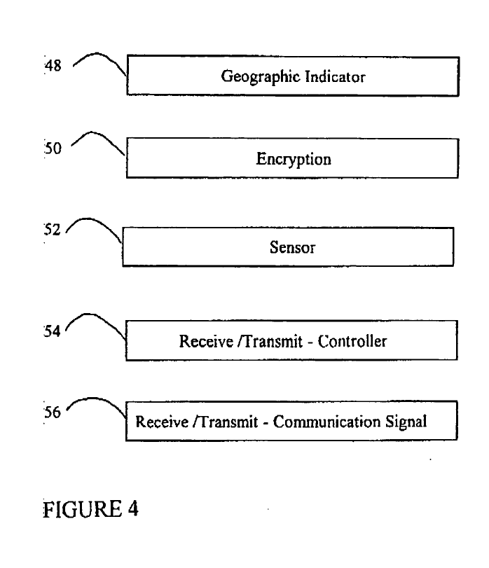

With reference to FIG. 4, the targeted device has a geographical indicator 48, previously described, and an encryption means 50 for encoding the target signal to prevent unauthorized determination of the geographical coordinates of the device. U.S. Pat. No. 5,325,432 describes the encryption of wireless signals. The device also has a sensor 52 for detecting tampering or rough handling or the device. Tampering or handling which exceeds a given threshold triggers a unique signal which is received by the receiver/transmitted for appropriate action. U.S. Pat. No. 6,362,778 discloses a sensor which is suitable for this purpose and the subject matter of this patent is incorporated into this application by reference.

The target device contains two other components, the components, generally 54 required to receive and transmit signals by means of which it communicates with the receiver/transmitter and the components generally 56, required to transmit and receive a communication signal which carries verbal and/or text messages. The same components are to be found on today's cellular telephones for carrying out the same functions.

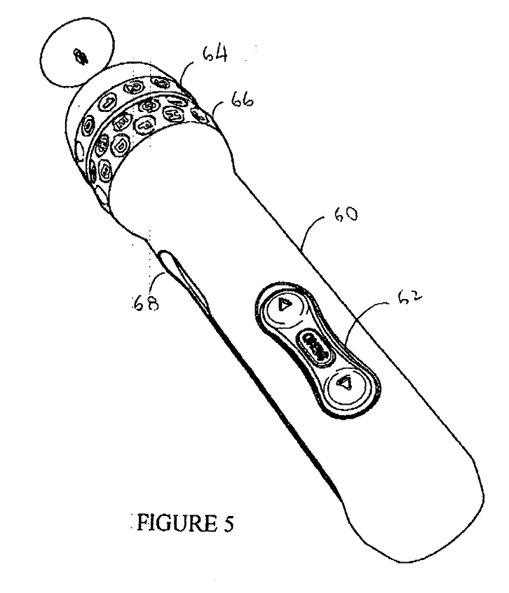

With reference to FIG. 5, the locating device 60 has a construction similar to that of the targeted device. It has an on-off switch 62 but lacks a combination lock for preventing the switch from being turned on or off. It has optional dials 64,66 to permit alphanumeric communication should that be desirable. A LED screen 68 is provided for alphanumeric communication.

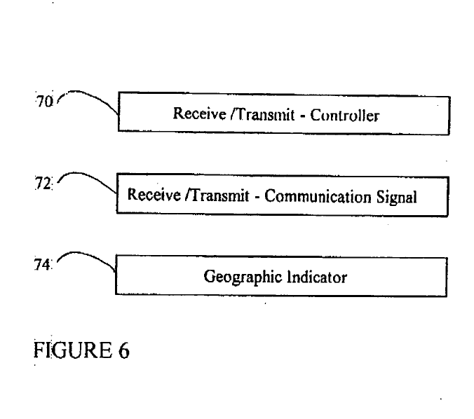

With reference to FIG. 6, the locating device has the components, generally 70 required to receive and transmit signals by means of which it communicates with the receiver/transmitter. Optionally, the device also has the components 72 necessary for transmission and receipt of a communication signal which carries verbal and/or text messages and a geographic indicator 74 such as GPS or A-GPS. A geographic indicator is useful where the locating device is used to locate a party or “target” in a crowd or in surroundings unfamiliar to the party who is doing the looking. The person doing the looking i.e. the “locator” can see on his locating device not only where the target is located but also where he, the locator, is located. It the locator can only determine the target's location but not his own, the locator may be unable to locate the target.

It will be understood of course that modifications can be made in the communication system of the invention without departing from the scope and purview of the invention as set out in the appended claims.

1. A communication system which enables one party to determine the location of another party and which also enables the party so located to carry on wireless communication, said system comprising a targeted transceiver which transmits a target signal identifying the geographical coordinates of said targeted transceiver; and a locating transceiver which has means by which the geographical coordinates of the targeted transceiver can be determined, the targeted transceiver having means for transmitting and receiving a communication signal which carries verbal and/or text messages.

2. A communication system which enables one party to determine the location of another party and which also enables the party so located to carry on wireless communication, said system comprising: a portable targeted transceiver which transmits a target signal identifying the geographical coordinates of the targeted transceiver in response to receipt of a locate signal; and a locating transceiver which causes the locate signal to be transmitted and which has means by which the geographical coordinates of the targeted transceiver can be determined, the targeted transceiver having means for transmitting and receiving a communication signal which carries verbal and/or text messages

3. The communication system of claim 1 wherein the targeted transceiver has locking means for preventing unauthorized blocking of the target signal.

4. The communication system of claim 1 wherein the targeted transceiver has user validation means for activating and deactivating the targeted transceiver.

5. The communication system of claim 1 wherein the targeted transceiver includes means for encoding said target signal to prevent unauthorized determination of the geographical coordinates of the targeted transceiver.

6. The communication system of claim 1 wherein the targeted transceiver includes a screen for displaying the geographical coordinates of the targeted transceiver.

7. The communication system of claim 1 wherein the locating transceiver includes means by which the geographical coordinates of the locating transceiver can be determined and displayed on the locating transceiver.

8. The communication system of claim 1 wherein the targeted transceiver includes means by which the geographical coordinates of the locating transceiver can be determined and displayed on the locating transceiver.

9. The communication system of claim 1 wherein the targeted transceiver includes a tamper detection sensor.

10. The communication system of claim 1 wherein each of the targeted and locating transceivers have means for transmitting and receiving a communication signal which permits verbal communication between the parties and/or which carries text messages.

11. The communication system of claim 1 further including a central control system having at least one wireless receiver/transmitter for receiving the target signal from the targeted transceiver, the locating transceiver having means for generating a locate signal, said control system having a user access validation means for validating the locate signal from the locating transceiver prior to transmission of a fifth signal which identifies the geographical coordinates of the targeted transceiver.

12. The communication system of claim 1 wherein the targeted transceiver has a user access validation means for preventing unauthorized use of the targeted transceiver.

13. The communication system of claim 1 wherein the targeted transceiver includes memory means for storing information concerning the geographical movement of the targeted over a given period of time.

14. The communication system of claim 11 wherein the locating transceiver includes memory means for storing information concerning the geographical movement of the targeted transceiver over the period of time that the locate signal is activated.

15. The communication system of claim 1 wherein the locating transceiver has a geographical indicator that identifies the geographical coordinates of the locating transceiver.

16. The communication system of claim 1 wherein said central control system includes memory means for storing information concerning the geographical movement of the targeted transceiver over a given period of time.
